(19) United States
(12) Patent Application Publication
(10) Pub. No.: US 2011/0011221 A1
(43) Pub. Date: Jan. 20, 2011

(54) Plasma Arc Cutting Torch, Oxygen-Fuel Gas Cutting Torch, Waterjet or Laser Cutting Torch, Pierce Height three or more Multi-Step Transition Height Process control for more than an initial pierce height and set cut height setting

(76) Inventor: Kerry Jon Pulaski, Gales Ferry, CT (US)

Correspondence Address: Mr. Kerry Jon Pulaski, 1541 Rt. 12, Gales Ferry, CT, 06335, US

(21) Appl. No.: 12/283,142

(22) Filed: Sep. 9, 2008

(51) Int. Cl. B26D 1/00

(52) U.S. Cl. 83/13

(57) ABSTRACT

The three or more multi-step material piercing cutting process sequence is to prolong the life of the cutting tool consumables and tool itself, lower cost of the operation to the machine user and reduce damage and loss of the material being cut with Plasma Arc cutting torches, Oxygen-Fuel Gas Cutting Torches, Water Jet Cutting Heads and Laser Cutting Heads. This process controlled by dedicated hardware or software or both, including external CNC machine or P.C. controllers, will provide unlimited cutting tool process height distance steps and the delay timing between each successive step to the work being cut before usual existing process control takes over the cut process. This process includes any control signal communication of these function from any analog, digital, wireless or fiberoptic to the equipment used for motion control of this process.

### BRIEF SUMMARY

I claim that this advanced multi positioning of the cutting torch (tool), during the initial piercing (blow through the material for a starting hole), can greatly extend the working life of the consumable parts, thus reducing downtime, lowering operating costs and increasing productivity.
The control of the cutting torch Multi-Step piercing process can be done either by mechanical or electronic regulation.

### DRAWING DESCRIPTION

In FIG. #1: there are a series of 10 sequences of events with my invention, that can apply to the piercing process for most cutting tools.

FIG. 1, Seq.1: The torch or tool decends to the work surface to find the starting reference base, from which the rest of the process heights are determined. This can be done mechanically, via a probe, or electronically.

FIG. 1, Seq. 2: The torch or tool raises to an initial process start height (in the case of plasma or oxy-fuel fame torches, to where the arc or flame can reliably start the cut process).

FIG. 1, Seq. 3: The torch or tool begins the gas or water pre-flow, prior to starting the cut process.

FIG. 1 Seq. 4: The torch or tool begins the piercing process by transfer of the cutting arc (plasma), flame (oxy-fuel), water (waterjet), laser beam etc.

FIG. 1 Seq. 5: The torch or tool is then raised after a specified time delay, to move the torch or tool away from the blowback of debris caused by the piercing process.

FIG. 1 Seq. 6: The torch or tool is then lowered after a suitable time delay, to a first transition distance towards a suitable cut height. This assists in stabilizing the cut process

FIG. 1 Seq. 7: The torch or tool is then lowered again after a suitable time delay, to a second transition distance towards a suitable cut height. This further assists in stabilizing the cut process.

FIG. 1 Seq. 8: The torch or tool is then lowered again after a suitable time delay, to a third transition height, to the same or nearly the same height, as the correct cutting height of steady state process cutting parameters. This minimizes the degradation of the cut surface as the torch or tool enters the cut path in motion in Seq. 9.

FIG. 1 Seq. 9: The torch or tool begins motion along the cut part path. It's height is now being controlled usually by a means of electronic regulation. This variable of height is determined by the torch or tool manufacturer.

FIG. 1 Seq. 10: The torch or tool cut process ends, and the torch or tool is raised to a pre set retract height, to avoid damage when traversing to the next starting location on the material.

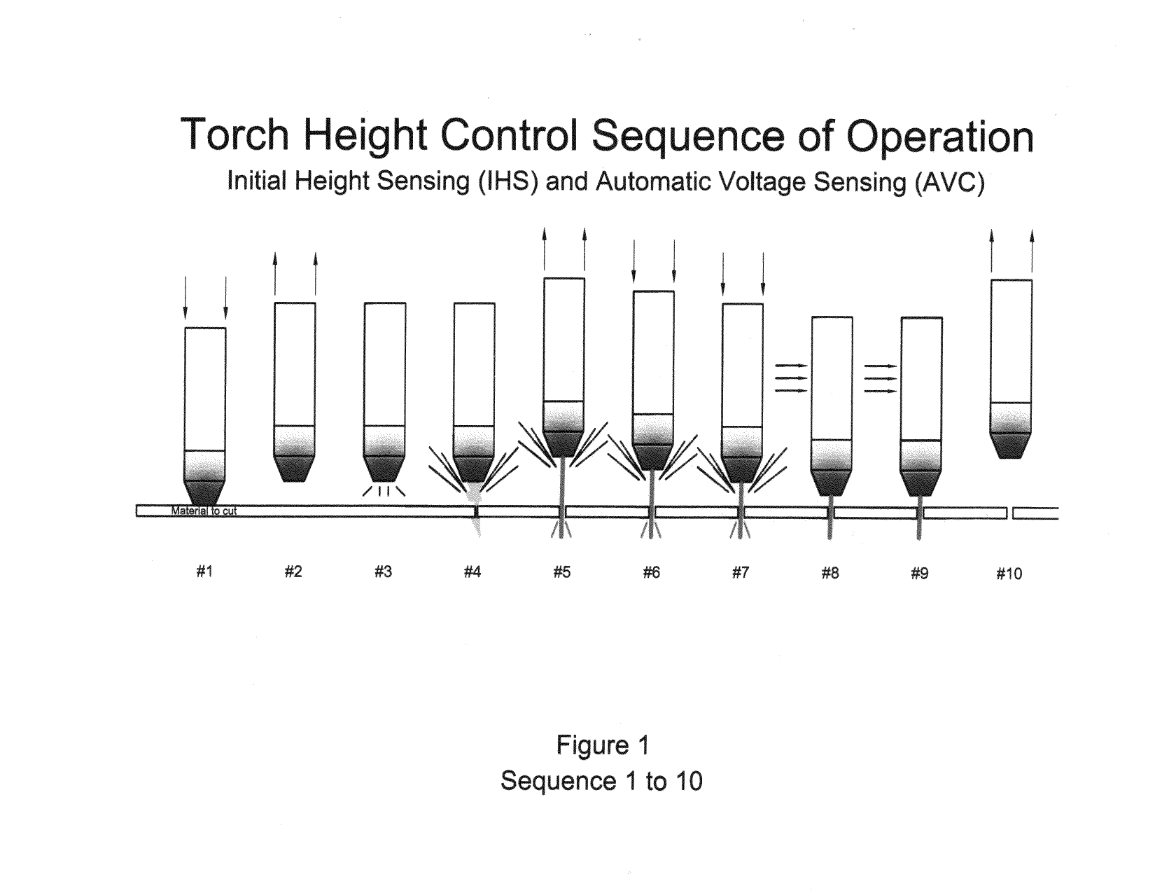

What is claimed is:

1. The purpose of this process is to greatly increase productivity and reduce costs, machine downtime due to cutting tool component failure and material scrap damage, from the existing industry accepted single and two step material piercing process of cutting tool motion. This process can be used an all mechanical motion devices and robotic applications.
